(19) United States
(12) Patent Application Publication
(10) Pub. No.: US 2020/0224833 A1
(43) Pub. Date: Jul. 16, 2020

(54) DECORATIVE LIGHT FIXTURE

(71) Applicant: Samira KRESO, Chicago, IL (US)

(72) Inventor: Samira KRESO, Chicago, IL (US)

(21) Appl. No.: 16/530,790

(22) Filed: Aug. 2, 2019

Related U.S. Application Data
(63) Continuation-in-part of application No. 29/676,576, filed on Jan. 11, 2019.

(51) Int. Cl. F21L 4/00; F21V 15/01; F21V 23/04

(52) U.S. Cl. CPC F21L 4/00; F21W 2121/00; F21V 23/04; F21V 15/01

(57) ABSTRACT

Embodiments of a decorative light fixture system include a light bulb, a base configured to be connected and receive the light bulb, and a battery holder. The battery holder is housed in the base and includes a first opening that receives a battery, a battery activation tab arranged between the battery and the light bulb and operable to insulate the light bulb from the battery. The decorative light fixture system further includes a securing structure that is arranged at one end of the base and includes a second opening. The battery activation tab is removable to release insulation of the light bulb from the battery and activate the light bulb.

### CROSS-REFERENCE TO RELATED APPLICATIONS

This application is a continuation-in-part application which claims the benefit of U.S. Design application Ser. No. 29/676,576 entitled “DECORATIVE LIGHT FIXTURE”, filed Jan. 11, 2019 which is hereby incorporated by reference as though fully set forth herein in its entirety.

### TECHNICAL FIELD

The present invention relates to a decorative light fixture, and more particularly, to a decorative light fixture for use in personalization, identification and decoration of personal items.

### BACKGROUND

It is common to prepare gifts or presents on special occasions, such as birthdays, holidays, anniversaries, etc. There are many options and different ways to personalize such gifts or presents. For instance, gifts or presents may be selected according to the nature of events for which such gifts or presents are prepared. As another example, gifts or presents may be personalized through wrappings or decorations. Wrapping papers, gift decorations such as colorful ribbons, stickers, etc., are frequently and commonly used.

In many cases, wrapping papers and/or materials or items used for gift decorations may be discarded once gifts or presents are opened. In other words, the use and functionality of those common gift wrapping options may be limited to and become useless once gifts are open. Thus, gift wrapping may be considered as undesirable or unnecessary items. Moreover, there is a considerable limit to personalization and decoration by using conventional gift wrapping, gift decorations, etc.

In addition to gifts or presents, it may be necessary or desired to identify or differentiate personal items. For instance, while travelling and checking in luggage, luggage having similar color and shape, such as black rectangular luggage, may cause confusion and result in swapping or loss of luggage. Personal identification such as a luggage tag, a ribbon, a bandana, etc. may be used for assisting identification and alerting other travelers to avoid unintended confusion.

Accordingly, there is a need or desire to provide a new and different way of personalizing gifts or presents. There is also a need or desire to expand the use of gift wrapping or decoration after gifts are open, such as recycling such gift decoration or providing a souvenir functionality. Furthermore, there is a need to personalize an individual item for identification, differentiation and decorative purposes beyond conventionally available means.

### SUMMARY

In order to address the above-described needs, embodiments described herein provide decorative light fixtures for personalization and/or identification of personal items.

One embodiment of a decorative light fixture system includes a light bulb, a base configured to be connected and receive the light bulb, and a battery holder. The battery holder is housed in the base and includes a first opening that receives a battery. A battery activation tab is arranged between the battery and the light bulb and operable to insulate the light bulb from the battery. A securing structure is arranged at one end of the base and includes a second opening.

In some embodiments, the battery activation tab is removable to release insulation of the light bulb from the battery. In other embodiments, the battery activation tab may be inserted back to turn off the activation of the light bulb. In another embodiment, the battery activation tab may be implemented with an on/off switch. The size and shape of the battery activation tab may vary based on the overall size and/or use of the decorative light fixture.

In some embodiments, the battery activation tab may be made of insulating materials such as plastic, paper, etc. The battery activation tab may trigger activation of a light bulb. For example, the battery tab insulates or blocks current flow between batteries and the light bulb and by removing or releasing the battery tab, the insulation or block of the current flow may be removed. In some embodiments, the battery activation tab may be able to be put back in the original position to turn off the light bulb. The present embodiments may not be limited to the battery tab and different mechanisms for activating the light bulb are available. For instance, an on/off switch, a sliding switch, etc. are possible.

In some embodiments, the decorative light fixture includes a light emitting diode (LED) module and a lamp housing that houses the LED module. In these embodiments, an LED light source is coupled to a base and may form the LED module. In some embodiments, the LED module is housed in the lamp housing that has a variety of shapes. For instance, the lamp housing may have various shapes such as candle, heart, star, balloon, driedel, etc. The shape of the lamp housing may be customized based on the needs and/or purposes of the occasion or individual.

In another embodiment, a portable light fixture system for identification and personalization includes a lamp housing that houses an LED light source, a support part connected to the LED light source and secures the LED light source, and a connection part that enables the lamp housing and the support part to be coupled to an article to be identified and personalized. The support part comprises a switch that activates the LED light source by removing the switch from the support part.

In further another embodiment, a decorative light fixture includes a LED light module, including a LED light source, a battery holder coupled to the LED and a battery contained in the battery holder and connected to the LED light source by means of a switch, and a base configured to receive the battery holder and the battery. The decorative light fixture further includes a lamp housing having a predetermined shape and configured to house the LED light source. Based on the predetermined shape, the lamp housing is further configured to selectively house the base. Accordingly, in some embodiments, the lamp housing houses the LED light module and the base and in other embodiments, the lamp housing houses the LED and the base is not housed within the lamp housing, based on the shape and/or structure of the lamp housing.

The foregoing and other aspects, features, details, utilities, and advantages of the present invention will be apparent from reading the following description and claims, and from reviewing the accompanying drawings.

### BRIEF DESCRIPTION OF THE DRAWINGS

FIGS. 1A-1C illustrate one embodiment of a decorative light fixture according to the present disclosure, wherein FIG. 1A shows a top perspective view of the decorative light fixture, FIG. 1B shows a cross-sectional view of the decorative light fixture of FIG. 1A, and FIG. 1C shows another perspective view of the decorative light fixture;

FIG. 2 illustrates an exploded view of the decorative light fixture of FIGS. 1A-1C in a dissembled state;

FIG. 3A illustrates a front view of the decorative light fixture of FIGS. 1A-1C, FIG. 3B illustrates a rear view of the decorative light fixture of FIGS. 1A-1C, FIG. 3C illustrates a left side view of the decorative light fixture of FIGS. 1A-1C, and FIG. 3D illustrates a right side view of the decorative light fixture of FIGS. 1A-1C;

FIG. 4A is a top plan view of the decorative light fixture of FIGS. 1A-1C without showing a light bulb, and FIG. 4B is a bottom plan view of the decorative light fixture of FIGS. 1A-1C;

FIG. 5A illustrates a front view of one embodiment of a battery holder of a decorative light fixture in a dissembled state, FIG. 5B illustrates a rear view of the battery holder of FIG. 5A, and FIG. 5C is a side view of the battery holder of FIG. 5A;

FIG. 6 illustrates one embodiment of a battery tab for use with the decorative light fixture;

FIG. 7 illustrates operation of the battery tab with respect to current flow, where the battery tab blocks current flow to am LED light source;

FIG. 8A illustrates a first exemplary use of the decorative light fixture of FIGS. 1A-1C, FIG. 8B illustrates a second exemplary use of the decorative light fixture of FIGS. 1A-1C, FIG. 8C illustrates a third exemplary use of decorative light fixture of FIGS. 1A-1C, and FIG. 8D illustrates a fourth exemplary use of the decorative light fixture of FIGS. 1A-1C;

FIGS. 9A and 9B illustrate a second embodiment of a decorative light fixture having a balloon shaped lamp housing according to the present disclosure, where FIG. 9A shows a LED light module within the balloon shape lamp housing and FIG. 9B shows a perspective view of the balloon shape lamp housing;

FIGS. 10A and 10B illustrate a third embodiment of a decorative light fixture having a dreidel shaped lamp housing according to the present disclosure, where FIG. 10A shows a perspective view of the dreidel shape lamp housing and FIG. 10B shows a LED light module within the dreidel shape lamp housing;

FIGS. 11A and 11B illustrate a fourth embodiment of a decorative light fixture having a heart shaped lamp housing according to the present disclosure, where FIG. 11A shows a perspective view of the heart shape lamp housing and FIG. 11B shows a LED light module within the heart shape lamp housing; and

FIGS. 12A and 12B illustrate a fifth embodiment of a decorative light fixture having a star shaped lamp housing according to the present disclosure, where FIG. 12A shows a perspective view of the star shape lamp housing and FIG. 12B shows a LED light module within the star shape lamp housing.

FIG. 13A illustrates one exemplary printed circuit board (PCB) component coupled to a light emitting diode (LED) light source and FIG. 13B illustrates another exemplary PCB component coupled to a LED light source.

### DETAILED DESCRIPTION OF THE EMBODIMENTS

Embodiments of the present disclosure are directed to a decorative light fixture for personalizing gifts, personal items, etc. The decorative light fixture may be coupled or attached to personal items, gifts, etc. and personalize an individual item for identification, differentiation and decorative purpose beyond conventionally available means. The decorative light fixture may expand the use of gift wrapping or decoration after gifts are open, such as recycling such gift decoration or providing souvenir functionality.

In some embodiments, the decorative light fixture system may include a light bulb, a base configured to be connected and receive the light bulb, and a battery holder. The battery holder is housed in the base and includes a first opening that receives a battery, a battery activation tab arranged between the battery and the light bulb and operable to insulate the light bulb from the battery. A securing structure is connected to the base and includes a second opening. The battery activation tab is removable to release insulation of the light bulb from the battery.

In other embodiments, an LED part and a base including a circuitry part may be integrally formed to be housed in a particular shaped lamp housing. Once the position of the LED part is selected to be suitable to light up the lamp housing, then the circuitry part is selectively positioned with respect to the lamp housing. The arrangement and the positioning of the LED part and the base may be determined to accommodate the shape and/or size of the lamp housing. In some embodiments, the LED part and the base may be separated and the LED part is housed in the lamp housing and the base is housed outside or inside of the lamp housing. Shapes of the lamp housing which houses the LED part and the base may not be limited to particular shapes and accommodate various shapes. Accordingly, the decorative light fixture of the present disclosure provides the structural advantages which enable various shapes and sizes to be used.

In some embodiments, the decorative light fixture includes a LED light module and a lamp housing that houses the LED light module. The lamp housing has a variety of shapes. For instance, the lamp housing may have various shapes such as candle, heart, star, balloon, driedel, etc. The shape of the lamp housing may be customized based on needs and/or purposes.

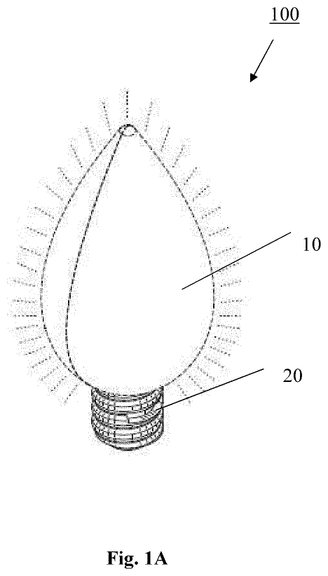

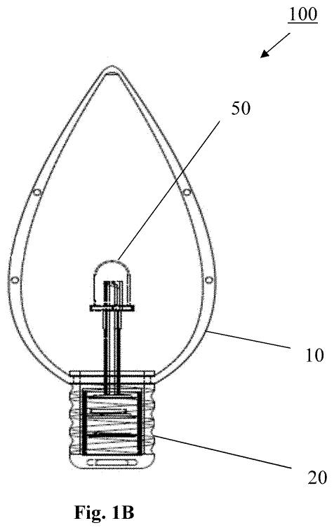

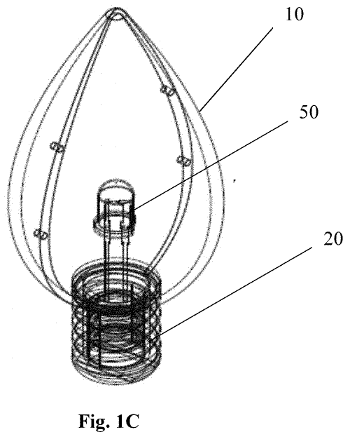

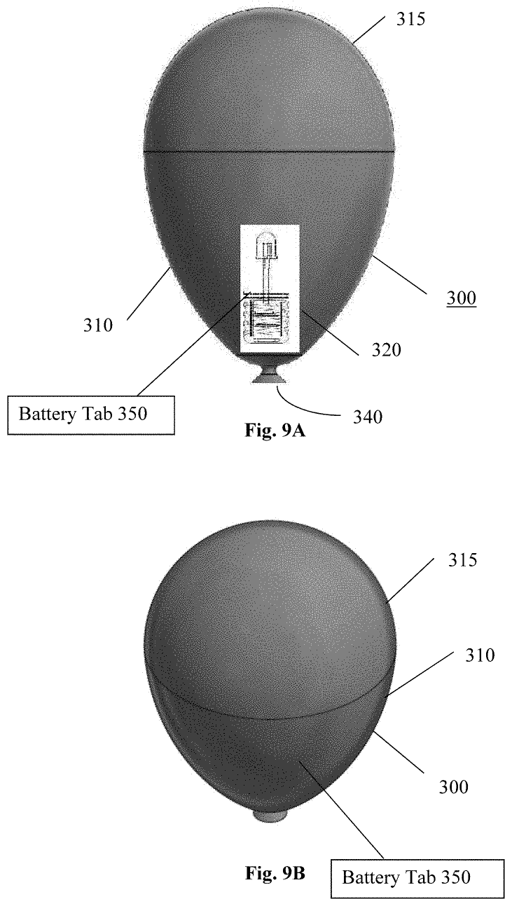

FIGS. 1A through 1C illustrate one embodiment of a decorative light fixture according to the present disclosure. The decorative light fixture 100 includes a light bulb 10 and a base 20. In this embodiment, the light bulb 10 has a candle shape, but the shape is not limited thereto. In other embodiments, the light bulb 10 has a different shape, such as arbitrary, spot, reflector, stick, spiral, or globe shape. The light bulb 10 may have a different shape from a typical light bulb shape, as will be described below in connection with FIGS. 9 through 12. The shape and size of the light bulb 10 may vary based on use of the light bulb 10 in various settings and in connection with associated personal items.

The light bulb 10 is connected to the base 20 and houses a light emitting diode (LED) lamp 50 which is connected to the base 20, as shown in FIGS. 1B and 1C. The light bulb 10 lights up after it is attached to, or connected with personal items such as gifts, luggage, pets, badges, etc. In some embodiments, the decorative light fixture 100 includes a switching mechanism that turns on the light bulb 10.

The light bulb 10 may be referred to as a lamp housing. In some embodiments, the lamp housing may be separated from the base 20, like the light bulb 10 as shown in FIG. 1A. In other embodiments, the lamp housing may include the LED light source 50 and the base 20 within the housing as shown in various embodiments of FIGS. 9A through 12B.

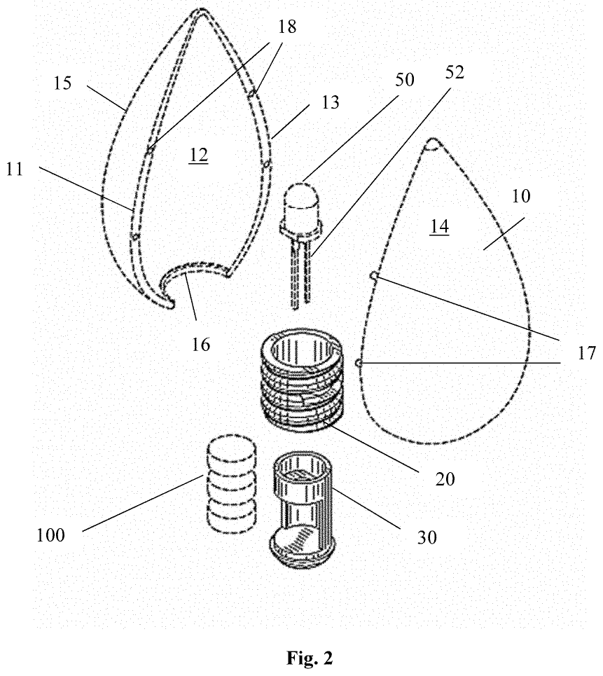

In some embodiments, the light bulb 10 may include two parts 12, 14 and each part corresponds to a half of the candle shape. Referring to FIG. 2, the two parts 12, 14 are coupled together by mechanical means. For example, one part 12 of the light bulb 10 includes two flanges 11, 13 that a curved wall 15 ends and extends from top to bottom of the half of the light bulb 10, as shown in FIG. 2. On each flange 11, 13, one or more holes 18 may be formed and arranged along the flanges 11, 13. The other part 14 of the light bulb 10 includes one or more protrusions 17 that match with the holes 18.

As shown in FIG. 2, parts 12 and 14 are coupled together by engaging the protrusions 17 with the holes 18. However, the light bulb 10 may be assembled in many different ways. For instance, the light bulb 10 may be formed as one integral unit rather than in two parts such as 12 and 14 attached together. In another embodiment, the two parts 12 and 14 may be attached or coupled chemically. The light bulb 10 has a bottom flange 16 that meets with the flanges 11 and 13. The bottom flange 16 is structured to have a matching shape with a corresponding part of the base 20. For instance, the base 20 has a cylindrical shape and the top of the base 20 may have a circular cross section. Accordingly, the bottom flange 16 is secured by rotating the light bulb 10 along spiral tracks formed on an external surface of the base 20. In other embodiments, the light bulb 10 may be secured to the base 20 in different ways.

In some embodiments, the dimensions of the decorative light fixture 100 are about 2.65 inches tall including the base 20, 1.175 inches wide at the widest part, and 0.45 inch wide at the base. The base 20 may be 0.65 inch tall. The decorative light fixture 100 may not be limited to the above-described dimensions and different dimensions are available based on uses of the decorative light fixture 100 in various settings. For instance, the size of the decorative light fixture 100 varies depending on the size of personal items used with the decorative light fixture 100.

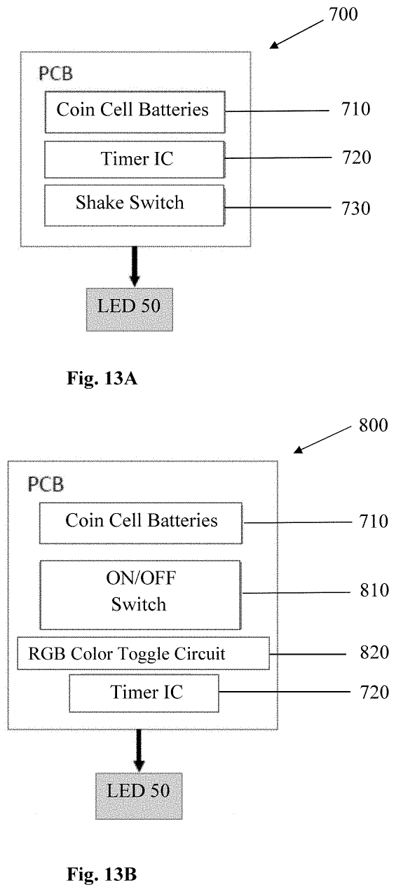

In some embodiments, the light bulb 10 may generate blinking lights and, upon activation, will blink on and off consistently. This may require a small size printed circuit board (PCB) component that controls blinking functions. By way of example, as shown in FIG. 13A, a PCB component 700 may include coin cell batteries 710, a timer IC (Integrated Circuit) 720, and a shake switch 730. This PCB component 700 may be connected to the LED light source 50. The PCB component 700 enables the LED light source 50 to perform additional functions such as motion-triggered blinking, blink with alternating colors, such as green/red, white/blue, etc. upon activation.

FIGS. 1A through 1C illustrate that the light bulb 10 is connected to the base 20. FIG. 2 shows an exploded view of the decorative light fixture 100 of FIGS. 1A-1C in a dissembled state. The base 20 is also coupled to a LED light source 50, a battery holder 30 and batteries 40. The battery holder 30 is housed in the base 20 and the batteries 40 are arranged within the battery holder 30. The LED light source 50 is received by the base 20 and electrically connected to the batteries 40 such that an electrical current is provided to the LED light source 50. The batteries 40 may include batteries that are known and available in the art.

In some embodiments, the LED light source 50 includes terminals 52 that extend therefrom and connects around the sides of the top of the batteries 40 such that the LED light source 50 fits under the top of the batteries 40. In other embodiments, the battery holder 30 may have structures such as openings that accommodate the terminals 52 of the LED light source 50.

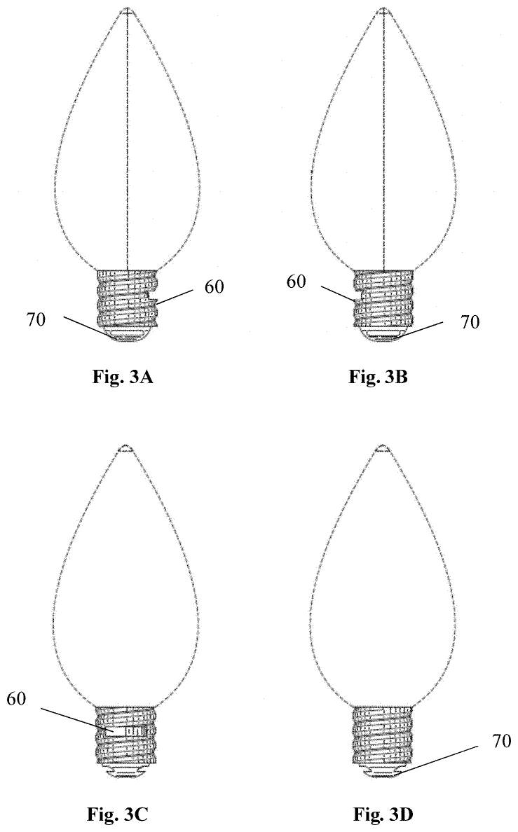

FIGS. 3A through 3D illustrate a front view, a rear review, a left side view and a right side view of the decorative light fixture 100 of FIGS. 1A-1C according to one embodiment. As shown in FIGS. 3A and 3B, the shape of the light bulb 10 is symmetrical and identical. In some embodiments, FIGS. 3A and 3B illustrate a slit 60 formed in the base 20. The slit 60 has a predetermined shape and is arranged at the middle point of the base 20 in some embodiments. In this embodiment, the slit 60 has a rectangular shape but the shape of the slit 60 is not limited thereto. The position of the slit 60 in the base 20 is not limited to the embodiments illustrated in FIGS. 3A through 3D.

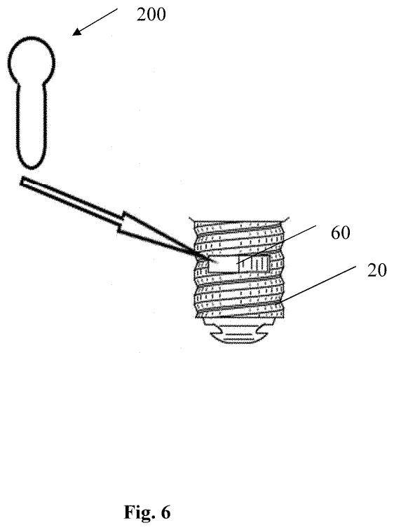

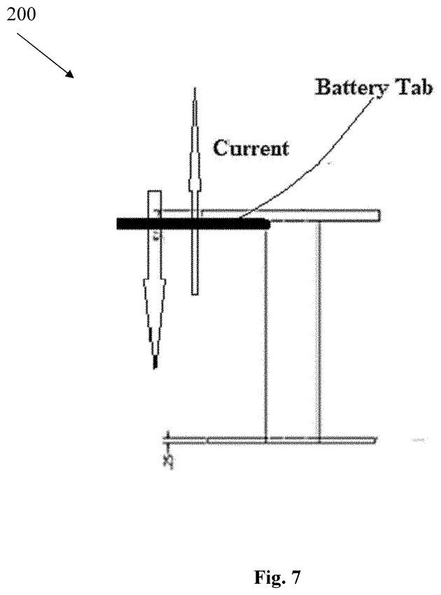

In some embodiments, the slit 60 is arranged to receive a battery tab 200, as shown in FIG. 6. The battery tab 200 is arranged to block or insulate current flow until the battery tab 200 is pulled and released from its position, as shown in FIGS. 6 and 7. In one embodiment, the battery tab 200 may be pulled once the decorative light fixture 100 is ready to be activated. In other embodiments, the battery tab 200 may be pushed back into the base 20 through the slit 60 and turn off the light bulb 10. It is possible to save batteries and extend the operation time of the decorative light fixture 100. In another embodiment, the base 20 includes a toggle switch that allows a user to turn on or off the light bulb 10. In that embodiment, a battery tab may not be exposed externally to the base 20 and rather, contained within the base 20. As the toggle switch is toggled, the battery tab may be moved or located to block or release current flow between the LED light source 50 and the batteries 40.

In some embodiments, as shown in FIG. 13B, a PCB component 800 including an on/off switch 810 may be coupled to the LED light source 50. The PCB component 800 may be arranged in the base 20 to be coupled to the LED light source 50. Additionally, the PCB component 800 includes a RGB color toggle circuit 820 that triggers the LED light source 50 to blink with different colors.

Referring back to FIG. 6, in some embodiments, the battery tab 200 may be made from a thin, flexible, strong polyester. In other embodiments, the battery tab 200 may be made from insulating materials such as paper. The size of the battery tab 200 is not limited to a particular dimension or size and may vary depending on uses and/or purposes of the decorative light fixture 100. In addition, the size of the battery tab 200 may vary based on the size of the decorative light fixture 100. For instance, when the size of the decorative light fixture 100 is large, then the size of the battery tab 200 is changed accordingly. The battery tab 200 may protrude from the decorative light fixture 100 through the slit 60 for access by a user of the decorative light fixture 100. Thus, when the decorative light fixture 100 is attached to other articles, users may easily access the battery tab 200 and activate the decorative light fixture 100 by pulling or releasing the battery tab 200. The battery tab 200 may come in various different forms and shapes and is not limited to the embodiments described herein.

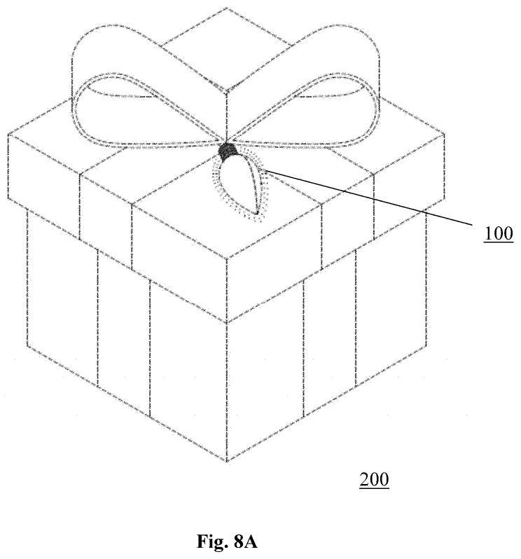

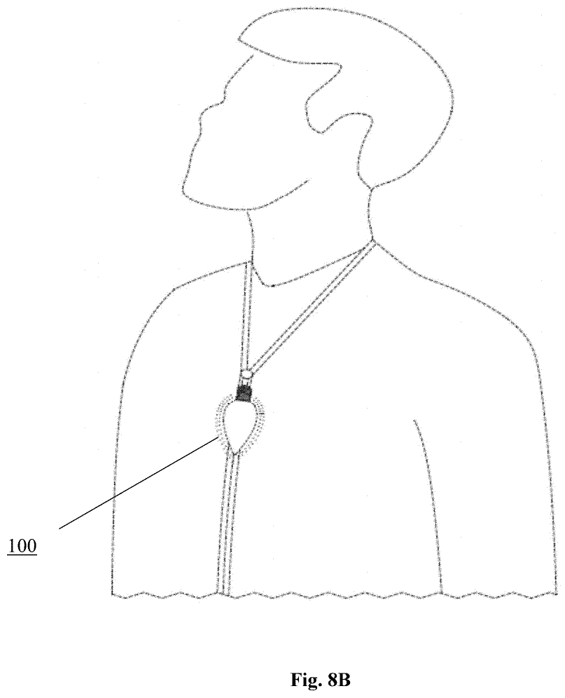

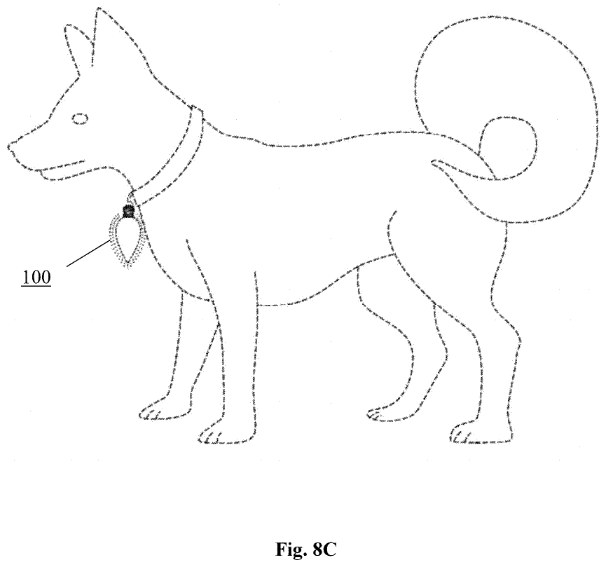

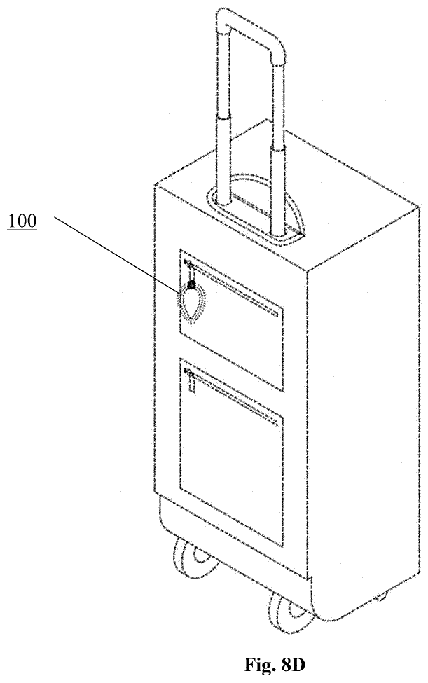

Referring back to FIG. 3A through FIG. 3D, the base 20 further includes a securing structure 70 that enables the decorative light fixture 100 to be attached or connected while in use. As illustrated in FIGS. 8A through 8D, the decorative light fixture 100 may be connected or attached to other articles for decoration, identification, personalization, or a combination thereof. The securing structure 70 includes a handle having a predetermined opening. The decorative light fixture 100 may be attached to other articles by using ribbons, buckles, clips, etc. The handle portion may include a part that opens and closes for easy attachment or more flexibility.

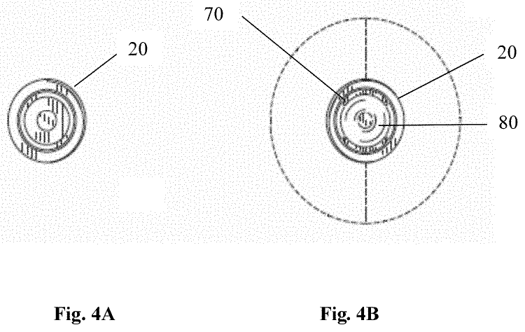

FIG. 4A illustrates a top plan view of the decorative light fixture 100 of FIGS. 1A-1C when the light bulb 20 is not attached. FIG. 4B illustrates a bottom plan view of the decorative light fixture 100 of FIG. 1A. On the bottom surface 80 of the base 20, the securing structure 70 appears, as shown in FIG. 4B.

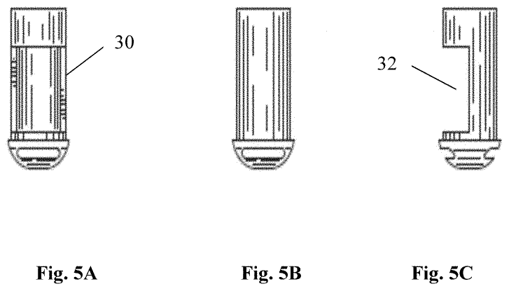

FIG. 5A illustrates a front view of one embodiment of a battery holder 30 of a decorative light fixture in a dissembled state, FIG. 5B illustrates a rear view of the battery holder 30 of FIG. 5A, and FIG. 5C is a side view of the battery holder 30 of FIG. 5A. The battery holder 30 includes a relatively large opening 32 along the vertical length of the battery holder 30. The opening 32 receives batteries and the dimensions and shape of the opening 32 and may vary depending on batteries to be inserted into the battery holder 30. The top surface of the battery holder 30 may receive the terminals of the LED light source 50. For example, the top surface may have a receiving hole (not shown) that receives the terminals of the LED light source 50. In some embodiments, the LED light source 50 is insulated and separated from the batteries by the battery tab 200 as discussed above in connection with FIG. 7. Once the battery tab 200 is pulled, the terminals of the LED light source 50 are electrically connected to the batteries and the LED light source 50 becomes turned on.

Referring to FIGS. 6 and 7, the battery tab 200 is further explained. The battery tab 200 is inserted into the slit 60 of the base 20 as shown in FIG. 6. The battery tab 200 is insertable and removable upon need and as the battery tab 200 is in and out of the base 20, a LED light source (not shown) is turned on and off. The shape of the battery tab 200 is not limited to the shape as shown in FIG. 6 and various different shapes are possible. The battery tab 200 may need to be shaped and sized to allow users to grab the battery tab 200 for removal and insertion. In other embodiments, the decorative light fixture 100 may have a first switch that turns on or off the LED light source 50. In further other embodiments, the decorative light fixture 100 may have a second switch that adjusts the brightness of the LED light source 50.

FIG. 8A through 8D illustrate several exemplar uses of the decorative light fixture 100 of FIGS. 1A-1C. These uses are by way of example and a person of ordinary skill in the art would know that the embodiments described in the present disclosure are not limited. FIG. 8A illustrates a first exemplary use of the decorative light fixture 100 for decoration of a present. Once the battery tab is pulled, the decorative light fixture 100 is activated. In some embodiments, the decorative light fixture 100 remains activated and turned on until the batteries have run out. The first exemplary use as shown in FIG. 8A may provide a new and useful way of decorating a present and personalization of a present.

FIG. 8B illustrates a second exemplary use of the decorative light fixture 100. In this example, the decorative light fixture 100 may be used for identification of a person for various purposes, such as identifying a meeting participant, a customer, an employee, a group, a reservation, etc. FIG. 8C illustrates a third exemplary use of decorative light fixture 100. The decorative light fixture 100 may be used to identify a pet, decorate and personalize a dog leash, etc.

FIG. 8D illustrates a fourth exemplary use of the decorative light fixture 100. The decorative light fixture 100 may be used for the purposes of personalization and identification of articles like a suitcase in a setting where such articles are publicly accessible by a particular group of people and may cause confusion, especially in the case where articles have similar colors and/or shapes.

FIGS. 9A and 9B illustrate a second embodiment of a decorative light fixture 300 having a balloon shape according to the present disclosure. The decorative light fixture 300 includes a LED light module 320, as shown in FIG. 9A. The LED light module 320 includes a LED bulb, a battery holder and batteries as shown in FIGS. 1A-1C and explanations as to the LED bulb, the battery holder and the batteries are omitted.

As shown in FIGS. 9A and 9B, the decorative light fixture 300 may not have an exposed base and contain the base, i.e., the LED light module 320 contained within the balloon shape. This structure may be more appealing to users for using the light fixture 300 for decorative purposes. Moreover, the decorative light fixture 300 includes a lamp housing having a top portion 315 and a bottom portion 310 which are separably coupled. The top portion 315 may be separated from the bottom portion 310 such that the LED light module 320 may be installed and arranged toward a bottom plate 340. Additionally, or alternatively, the bottom plate 340 may be separated for easy assembly, for the purpose of changing batteries, etc. In other embodiments, the lamp housing 300 may be formed as a single unit. The bottom plate 340 may include connection means that facilitates connection of the decorative light fixture 300 with items such as gifts, luggage, a dog leash, etc.

The lamp housing 310, 315 will light up when the LED light module 320 is activated. Thus, the lamp housing 310, 315 may be made of material that enables the light from the LED light module 210 visible. For example, the lamp housing 310, 315 may be made of glass, plastic, etc.

The decorative light fixture 300 also includes a battery tab 350 connected with the bottom portion 310 of the lamp housing such that an LED light source of the LED light module 320 may be activated. In FIGS. 9A and 9B, the battery tab 350 is illustrated, but the present embodiment is not limited thereto. For instance, an on/off switch, or other switching mechanism may be available, as shown in FIG. 13B. The dimensions of the bottom plate 340 may vary, and as long as the LED light module 320 is housed in the bottom portion 310, the dimensions of the LED light module 320 may vary accordingly.

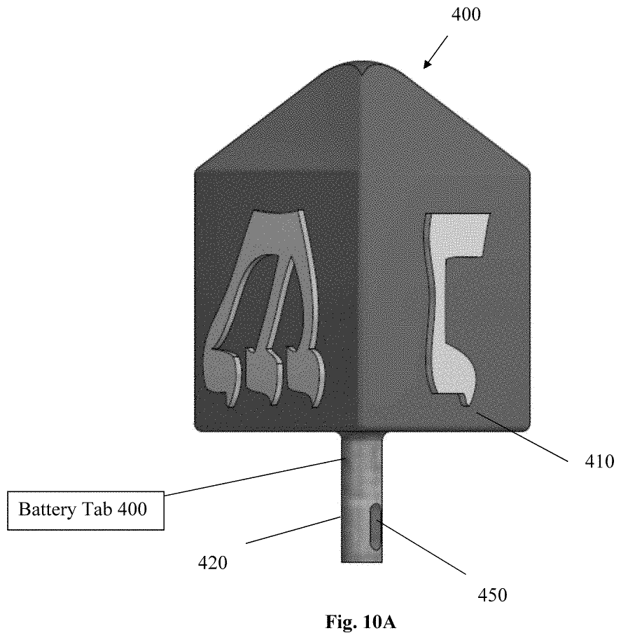

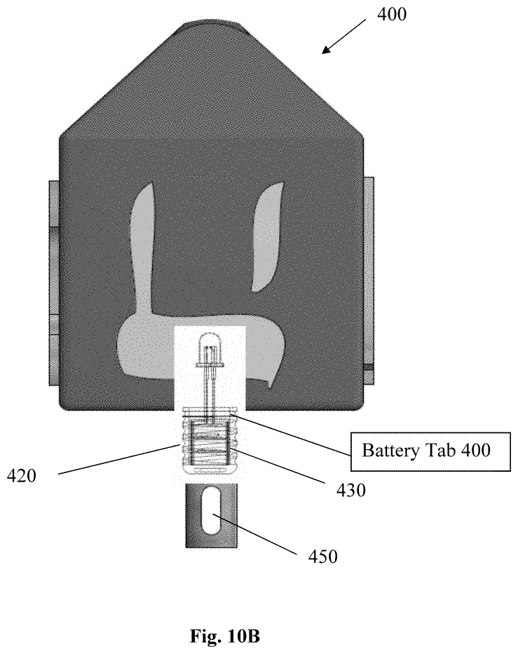

FIGS. 10A and 10B illustrate a third embodiment of a decorative light fixture 400 having a dreidel shape according to the present disclosure. The decorative light fixture 400 includes a lamp housing 410 and a base 420 including a LED light module 430, as shown in FIG. 10B. The LED light module 430 includes a LED light source, a battery holder and batteries as shown in FIGS. 1A through 1C and explanations as to the LED light source, the battery holder and the batteries are omitted. The base 420 further includes an opening 450 that receives connection means or securing means such as ribbons, clips, key chains, etc. such that the decorative light fixture 400 can be coupled to other personal items.

As shown in FIG. 10B, a LED light source of the LED light module 430 is arranged within the lamp housing 410. Once the LED light source is activated, the lamp housing 410 will light up. Thus, the lamp housing 410 may be made of material that enables the light from the LED light source visible.

The decorative light fixture 400 also includes a battery tab 470 connected with the base 420 such that the LED light source may be activated. In FIGS. 10A and 10B, the battery tab 400 is illustrated, but the present embodiment is not limited thereto. For instance, an on/off switch, or other switching mechanism may be available. The dimensions of the base 420 may vary, and as long as the LED light source is housed in the lamp housing 410, the dimensions of the LED light module 420 may vary accordingly.

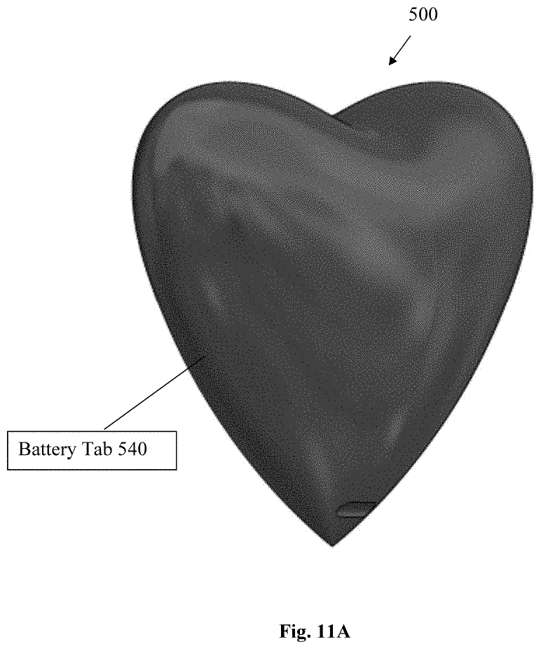

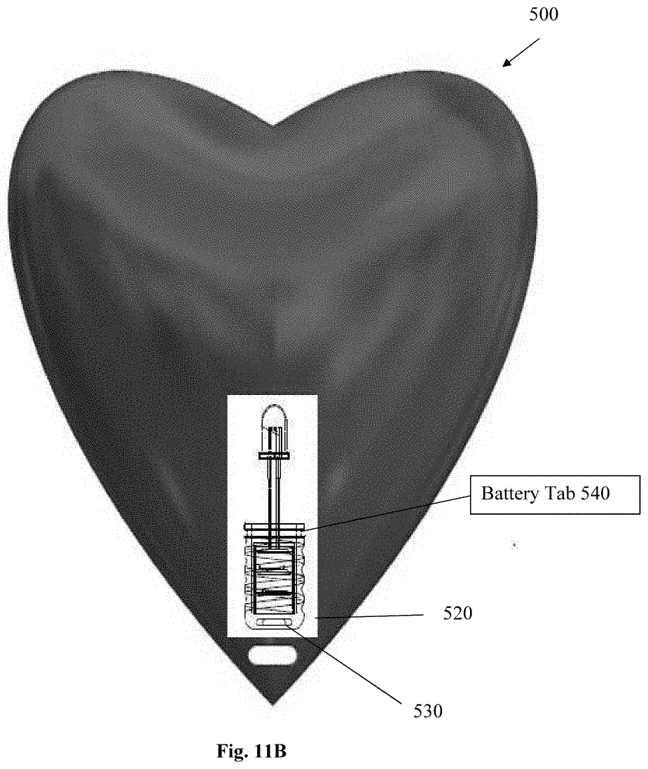

FIGS. 11A and 11B illustrate a fourth embodiment of a decorative light fixture 500 having a heart shape according to the present disclosure. The decorative light fixture 500 includes a LED light module 520, as shown in FIG. 11B. The LED light module 520 includes a LED light source, a battery holder and batteries as shown in FIGS. 1A-1C and explanations as to the LED light source, the battery holder and the batteries are omitted. The decorative light fixture 500 includes an opening 530 that facilitates connection with personal items. Once the LED light source is activated, the decorative light fixture 500 of heart shape lights up.

As shown in FIGS. 11A and 11B, a battery tab 540 is connected to the decorative light fixture 500. The battery tab 540 is connected with the LED light module 520 and exposed externally to the heart shaped light fixture 500. As discussed above, the battery tab 540 may be inserted and/or removed. FIGS. 11A and 11B show the battery 540 tab but the present disclosure is not limited thereto. For instance, an on/off switch may be installed, instead of the battery tab 540, in order to turn on and off the LED light module 520, as shown in FIG. 13B. In some embodiments, a housing of the heart shaped light fixture 500 may be accessed externally such that batteries can be replaced.

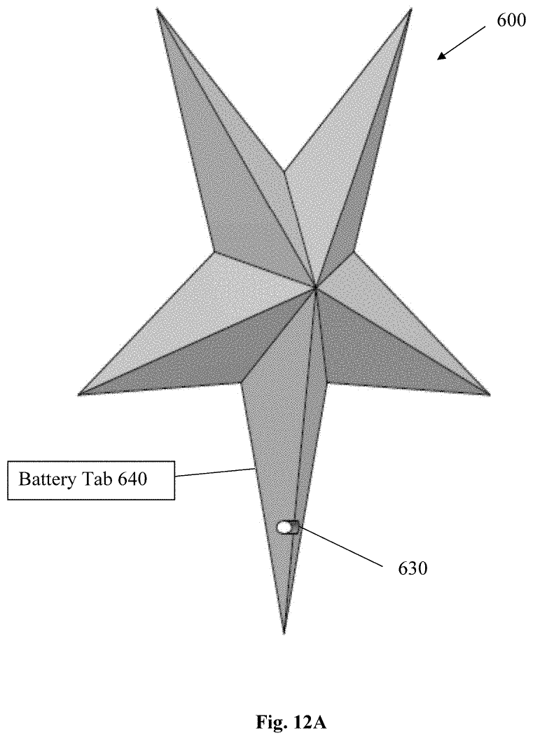

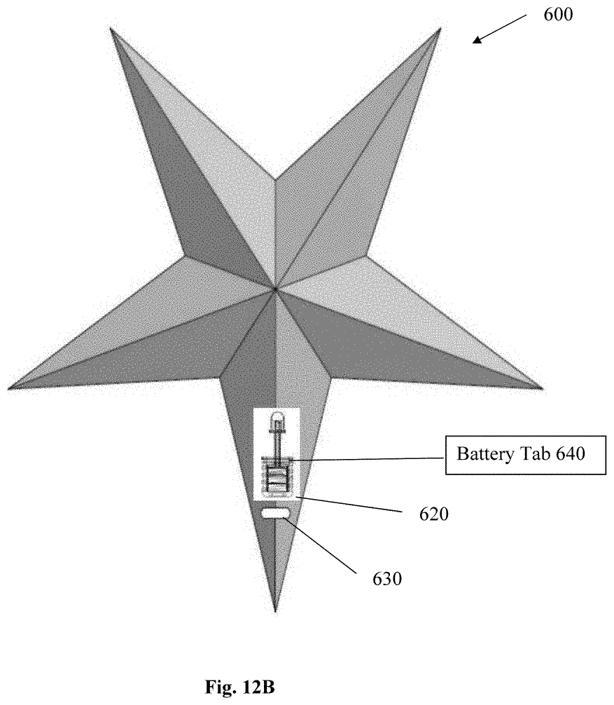

FIGS. 12A and 12B illustrate a fourth embodiment of a decorative light fixture 600 having a star shape according to the present disclosure. The decorative light fixture 600 includes a LED light module 620, as shown in FIG. 12B. The LED light module 620 includes a LED light source, a battery holder and batteries as shown in FIGS. 1A-1C and explanations as to the LED light source, the battery holder and the batteries are omitted. The decorative light fixture 600 includes an opening 630 that facilitates connection with personal items. Once the LED light source is activated, the decorative light fixture 600 of the star shape lights up.

As shown in FIGS. 12A and 12B, a battery tab 640 is connected to the decorative light fixture 600. The battery tab 640 is connected with the LED light module 620 and exposed externally to the star shaped light fixture 600. As discussed above, the battery tab 640 may be inserted and/or removed. FIGS. 12A and 12B show the battery tab 640 but the present disclosure is not limited thereto. For instance, an on/off switch may be installed, instead of the battery tab 640, in order to turn on and off the LED light module 620, as shown in FIG. 13B. In some embodiments, a housing of the star shaped light fixture 600 may be accessible externally such that batteries can be replaced.

In the embodiments described above, the decorative light fixture system includes a light source, a base configured to be connected and receive the light source, a battery holder that is housed in the base, and a securing structure that is arranged at one end of the base and including a second opening. The battery holder includes a first opening that receives a battery, and a battery activation tab. The battery activation tab is arranged between the battery and the light source and operable to insulate the light source from the battery. The battery activation tab is removable to release insulation of the light source from the battery.

In some embodiments, the light source includes a light emitting diode (LED) and is secured to the base. In some embodiments, the decorative light fixture system further includes a light bulb that houses the light source and has a shape selected from one of a candle shape, a star shape, a dreidel shape, a heart shape, and a balloon shape. In some embodiments, the base includes a slit operable to receive the battery activation tab and the battery activation tab is protruded externally relative to the base through the slit.

In another embodiment, when the battery activation tab is pulled through the slit, the light source is activated and remains turned on. In another embodiment, the base further includes a switch that turns off the LED. In yet another embodiment, the securing structure includes a releasing part that is openable and closable for connection with an article.

In the embodiments described above, a portable light fixture system for identification and personalization, includes a lamp housing that houses an LED part, a support part connected to the LED part and secures the LED part, and a connection part. The connection part enables the lamp housing and the support part to be coupled to an article to be identified and personalized by means of the portable light fixture system. The support part includes a switch that activates the LED part by removing the switch from the support part.

In another embodiment, the support part includes a battery holder that includes a first opening that receives a battery, and the switch includes a battery activation tab arranged between the battery and the LED part and operable to insulate the LED part from the battery. The battery activation tab is removable to release insulation of the LED part from the battery. In yet another embodiment, the lamp housing includes a shape selected from one of a candle shape, a star shape, a dreidel shape, a heart shape, and a balloon shape. In yet another embodiment, when the battery activation tab is removed and released, the LED part remains turned on.

In the embodiments described above, the decorative light fixture includes a LED light module, including a LED, a battery holder coupled to the LED and a battery contained in the battery holder and connected to the LED by means of a switch. The decorative light fixture further includes a base configured to receive the battery holder and the battery, and a lamp housing having a predetermined shape and configured to house the LED. The lamp housing is further configured to selectively house the base based on the predetermined shape. In some embodiments, the decorative light fixture further includes a securing structure that couples the decorative light fixture to a personal item. The lamp housing houses the LED light module and the base within the lamp housing such that the LED light module and the base are invisible from an outside of the lamp housing.

In some embodiments, the predetermined shape includes a first part and a second part, and the base is housed in the second part and the LED is housed in the first part. In other embodiments, the base is housed in the second part and the LED is housed in the first part and the securing structure is arranged with the second part.

In the embodiments described above, embodiments of a decorative light fixture system include a light bulb, a base configured to be connected and receive the light bulb, and a battery holder. The battery holder is housed in the base and includes a first opening that receives a battery, a battery activation tab arranged between the battery and the light bulb and operable to insulate the light bulb from the battery. A securing structure is arranged at one end of the base such as a bottom end of the base, and includes a second opening. The battery activation tab is removable to release insulation of the light bulb from the battery. The light bulb has a variety of shapes, such as candle, heart, star, balloon, driedel, etc.

In some embodiments, the battery tab may be made of insulating materials such as plastic, paper, etc. The battery tab may trigger activation of the light bulb. For example, the battery tab insulates or blocks current flow between batteries and the light bulb and by removing or releasing the battery tab, the insulation or block of the current flow may be removed. In some embodiments, the battery tab may be put back in the original position to turn off the light bulb.

The present embodiments may not be limited to the battery tab and different mechanisms for activating the light bulb are available. For instance, an on/off switch, a sliding switch, etc. are possible.

The securing structure facilitates connection between the decorative light fixture and other personal items by means of ribbons, clips, key chains, etc. Various securing structures are possible based on the uses and purposes of connection between the decorative light fixture and other personal items.

In the embodiments described above, the LED light source and the base housing the circuitry part and the battery may be housed in a lamp housing. The lamp housing may have various shapes such as candle, heart, star, balloon, driedel, etc. The shape of the lamp housing may be customized based on needs and/or purposes. Depending on the shape of the lamp housing, the LED light source may be housed in the lamp housing and the base may be arranged separately. Alternatively, the LED light source and the base may be housed in the lamp housing and not externally visible. Upon activation, it will appear that the entire lamp housing lights up.

The dimensions of the decorative light fixture widely vary in the setting that the decorative light fixture is used. Moreover, the arrangement and the position of the LED light source and the base may vary based on the structure and shape of a lamp housing of the decorative light fixture. For example, in the structure that the LED light source and the base are separated, the decorative light fixture is structured to position the LED light source within the lamp housing. In the structure where the lamp housing is used, the LED light source and the base may be housed in the lamp housing, or the base may be housed outside of the the lamp housing.

The above specification, examples and drawings provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although implementations have been described above with a certain degree of particularity, those skilled in the art could make numerous alterations to the disclosed embodiments without departing from the spirit or scope of this invention. For example, while some implementations provide optimal or near-optimal results, others can be constructed to provide improved results without necessarily achieving optimal or even near-optimal results. Further, while examples use various time periods, media choices and the like, these are merely exemplary and not limiting unless expressly recited in the claims. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A decorative light fixture system, comprising:
a light source;
a base configured to be connected and receive the light source;
a battery holder that is housed in the base, comprising:
a first opening that receives a battery;
a battery activation tab arranged between the battery and the light source and operable to insulate the light source from the battery, wherein the battery activation tab is removable to release insulation of the light source from the battery; and
a securing structure that is arranged at one end of the base and including a second opening.

2. The system of claim 1, further comprising a light bulb housing the light source and coupled to the base, wherein the light source includes a light emitting diode (LED).

3. The system of claim 1, further comprising a light bulb housing the light source and having a shape selected from one of a candle shape, a star shape, a dreidel shape, a heart shape, and a balloon shape.

4. The system of claim 1, wherein the base includes a slit operable to receive the battery activation tab and the battery activation tab is protruded externally relative to the base through the slit.

5. The system of claim 4, wherein when the battery activation tab is pulled through the slit, the light source is activated and remains turned on.

6. The system of claim 2, wherein the base further comprises a switch that turns off the LED.

7. The system of claim 1, wherein the securing structure includes a releasing part that is openable and closable for connection with an article.

8. A portable light fixture system for identification and personalization, comprising:
a lamp housing that houses an LED part;
a support part connected to the LED part and secures the LED part; and
a connection part that enables the lamp housing and the support part to be coupled to an article to be identified and personalized by means of the portable light fixture system;
wherein the support part comprises a switch that activates the LED part by removing the switch from the support part.

9. The system of claim 8, wherein the support part comprises a battery holder that includes a first opening that receives a battery, and the switch comprises a battery activation tab arranged between the battery and the LED part and operable to insulate the LED part from the battery, wherein the battery activation tab is removable to release insulation of the LED part from the battery.

10. The system of claim 8, wherein the lamp housing includes a shape selected from one of a candle shape, a star shape, a dreidel shape, a heart shape, and a balloon shape.

11. The system of claim 9, wherein when the battery activation tab is removed and released, the LED part remains turned on.

12. The system of claim 8, wherein the connection part includes a releasing part that is openable and closable for connection with an article.

13. A decorative light fixture, comprising:
a LED light module, including a LED, a battery holder coupled to the LED and a battery contained in the battery holder and connected to the LED by means of a switch;
a base configured to receive the battery holder and the battery; and
a lamp housing having a predetermined shape and configured to house the LED, the lamp housing further configured to selectively house the base based on the predetermined shape.

14. The decorative light fixture of claim 13, further comprising a securing structure that couples the decorative light fixture to a personal item;
wherein the lamp housing houses the LED light module and the base within the lamp housing such that the LED light module and the base are invisible from an outside of the lamp housing.

15. The decorative light fixture of claim 13, wherein the predetermined shape comprises a first part and a second part, and the base is housed in the second part and the LED is housed in the first part.

16. The decorative light fixture of claim 14, wherein the predetermined shape comprises a first part and a second part, and the base is housed in the second part and the LED is housed in the first part and the securing structure is arranged with the second part.
